(19) United States
(12) Patent Application Publication
(10) Pub. No.: US 2024/0128464 A1
(43) Pub. Date: Apr. 18, 2024

(54) Current Collector, Battery Electrode Plate, and Battery

(71) Applicant: ZHUHAI COSMX BATTERY CO., LTD., Zhuhai (CN)

(72) Inventors: Shuanghu ZHANG, Zhuhai (CN); Yuanhong LYU, Zhuhai (CN); Pan ZHU, Zhuhai (CN); Ze ZHONG, Zhuhai (CN); Jichun XIE, Zhuhai (CN)

(73) Assignee: ZHUHAI COSMX BATTERY CO., LTD., Zhuhai (CN)

(21) Appl. No.: 18/320,143

(22) Filed: May 18, 2023

(30) Foreign Application Priority Data
May 18, 2022 (CN) 202221197805.6

(51) Int. Cl. H01M 4/66; H01M 4/80

(52) U.S. Cl. CPC H01M 4/667; H01M 4/80; H01M 2004/021

(57) ABSTRACT

Disclosed are a current collector, an electrode plate, and a battery. The current collector includes a substrate and a conductive coating layer coated on the surface of the substrate, where the conductive coating layer includes alternately arranged raised parts and recessed parts. A plurality of recessed parts are arranged on the conductive coating layer, which may increase the component of the coated active material without increasing the overall thickness, significantly increase the bonding strength of the active material and the conductive coating layer, and improve the conductivity; it can effectively inhibit the thickness expansion of the electrode plate, and solve the problem that the bonding strength of the carbon-containing layer and the active material in the prior art needs to be improved.

### CROSS-REFERENCE TO RELATED APPLICATIONS

The present application claims priority to Chinese Patent Application No. 202221197805.6, filed on May 18, 2022, which is hereby incorporated by reference in its entirety.

### TECHNICAL FIELD

The present disclosure relates to the technical field of batteries, and in particular, to a current collector, a battery electrode plate, and a battery.

### BACKGROUND

With the rapid development of the electronic product industry, the requirements for battery performance are getting higher and higher, such as higher energy density, higher rate performance, and longer service life. The main components of a battery include an active material, a separator, an electrolyte, a current collector, and the like. Generally, the current collector of the battery is made of metal foil, and the surface of the foil is coated with the active material to form an electrode plate. However, the rolling surface of the metal foil is relatively smooth, when coating active materials, there will be phenomena such as poor wettability, loose bonding, low bonding strength, small bonding area, and poor adhesion, which lead to the problems of large interface resistance between the active material and the current collector, easy separation in the charging and discharging process, and the like. These problems may reduce battery performance such as serious polarization caused by the large interface resistance, and affect lithium storage capacity, rate performance, and cycle performance of the battery, thus it is difficult to meet the current requirements for high rate performance, high energy density, and long cycle life. Therefore, improving the surface state and properties of the metal foil, thereby improving the compatibility, bonding strength, and bonding area between the active material and the current collector, is of great significance for improving the battery performance

Currently, a common method is to use a carbon-containing material to coat and bound on the surface of the metal foil to form a conductive carbon-containing coating layer, thereby improving the surface properties of the foil; and the active material is coated on the carbon-containing coating layer to enhance the bonding strength between the current collector and the active material. However, some problems still exist, such as poor conductivity, difficult dispersion of the conductive material, loose bonding strength between the coating layer and the active material, thicker coating layer, and the like. The bonding strength between the carbon-containing coating layer and the active material is particularly important, which seriously affects bonding strength, compatibility, and bonding area between the current collector and the active material. If the content of the binder in the coating layer is increased, the bonding performance may be enhanced to a certain extent; but the conductivity is easier to reduce, and the problem that the coating layer is too thick and occupies too much battery space is also easily caused. Therefore, how to improve the bonding performance between the carbon-containing coating layer and the active material, without increasing the content of the binder, has become an important aspect of improving the performance of the current collector.

### SUMMARY

Objectives of the present disclosure is to provide a current collector, which improves the bonding strength between conductive coating layer and active material by optimizing the structure of the conductive coating layer, to solve the problem in the prior art that the bonding strength between the carbon-containing layer and the active material needs to be improved. The present disclosure is further directed to providing an electrode plate and a battery including the above-mentioned current collector.

One aspect of the present disclosure provides a current collector, including a substrate and a conductive coating layer coated on the surface of the substrate, where the conductive coating layer comprises alternately arranged raised parts and recessed parts.

In a possible implementation, the raised parts comprises raised stripes, which are convex and arranged at intervals along a first direction; and the recessed parts comprises a recessed thin layer, located between two adjacent raised stripes, and forming a recessed structure on the conductive coating layer.

In a possible implementation, a plurality of blank areas, not coated with the conductive coating layer, are distributed on the recessed thin layer.

In a possible implementation, the blank areas are distributed in a matrix; and/or the blank areas are arranged in multiple-rows, and the blank areas of two adjacent rows are arranged in a staggered manner.

In a possible implementation, the diameter of the blank area is 10 μm-50 μm; and/or the distance between two adjacent blank areas is 80 μm-120 μm.

In a possible implementation, the distance between two adjacent raised stripes is 60 μm-250 μm.

In a possible implementation, the width of the raised stripe is 30 μm-150 μm.

In a possible implementation, the pore size of the conductive coating layer ranges from 50 nm to 2000 nm.

In a possible implementation, the thickness of the conductive coating layer is 0.4 μm-0.8 μm; and/or the thickness of the current collector is 0.1 μm-2 μm.

In a possible implementation, the volume resistance of the current collector is 1 mΩ-5 mΩ.

In a possible implementation, the surface roughness of the substrate ranges from 0.2 μm to 3 μm.

In a possible implementation, the thickness of the substrate ranges from 3 μm to 10 μm.

In a possible implementation, the volume resistance of the substrate ranges from 0.5 mΩto 10 mΩ.

In a possible implementation, a dispersant of the conductive coating layer is polyvinyl pyrrolidone and/or carboxymethyl cellulose material.

In a possible implementation, a binder of the conductive coating layer is a polyacrylic acid aqueous binder.

In a possible implementation, the substrate is configured to be any one of the following materials: a metal foil; stainless steel or aluminum-cadmium alloy, plated with carbon, nickel, titanium, or silver on the surface; a polymeric membrane deposited with a conductive layer; or a substrate formed by laminating and compounding a polymeric membrane and a metal foil.

The present disclosure further provides a battery electrode plate, including the current collector as described above and an active material layer coated on the surface of the current collector.

In a possible implementation, a tab is positioned on the surface of the electrode plate and located on the surface of the substrate; or the tab is located on the surface of the conductive coating layer away from the substrate.

In a possible implementation, a tab is positioned on one side of the substrate; and on the other side of the substrate, an area, opposite to the tab, is a blank foil area, or coated with a conductive coating, with or without being coated by an active material layer.

In a possible implementation, the conductive coating is coated by an active material layer completely or partially; and, the active material layer covers the conductive coating layer, and the edge of the active material layer exceeds the corresponding edge of the conductive coating layer; the size of the exceeding part is a, and the value of a is 0-5 mm; or the edge of the conductive coating layer exceeds the edge of the corresponding active material layer; the size of the exceeding part is b, and the value range of b is 0-5 mm.

The present disclosure further provides a battery, including the current collector, and/or the battery electrode plate as described above.

According to the current collector provided by the present disclosure, the conductive coating layer is positioned on the substrate to improve the surface performance of the current collector; meanwhile, the conductive coating layer includes raised parts (such as raised stripes) arranged at intervals and recessed parts (such as a recessed thin layer located between two adjacent raised stripes, so that a plurality of recessed areas are formed). Therefore, when the conductive coating layer is coated with active material, more active materials may be filled in the recessed areas. On one hand, the component of the active material may be increased without increasing the overall thickness, thereby improving the conductivity; on the other hand, the active material and the conductive coating layer form an embedded insertion combined structure, which may effectively improve the bonding area and the compatibility degree between the active material and the conductive coating layer, make the two tightly combined, significantly increase the bonding strength between the active material and the conductive coating layer.

### BRIEF DESCRIPTION OF THE DRAWINGS

FIG. 1 is a schematic structural diagram of the conductive coating layer according to another embodiment of the present disclosure.

FIG. 2 is a variation of the cell thickness expansion rate of the battery according to the number of cycles of charging and discharging provided by an embodiment of the present disclosure.

FIG. 3 is a schematic diagram of the coating layer distribution of a battery electrode plate according to an embodiment of the present disclosure.

FIG. 4 is a second schematic diagram of the coating layer distribution of a battery electrode plate according to an embodiment of the present disclosure.

FIG. 5 is a third schematic diagram of the coating layer distribution of a battery electrode plate according to an embodiment of the present disclosure.

FIG. 6 is a fourth schematic diagram of the coating layer distribution of a battery electrode plate according to an embodiment of the present disclosure.

FIG. 7 is a fifth schematic diagram of the coating layer distribution of a battery electrode plate according to an embodiment of the present disclosure.

FIG. 8 is a sixth schematic diagram of the coating layer distribution of a battery electrode plate according to an embodiment of the present disclosure.

FIG. 9 is a seventh schematic diagram of the coating layer distribution of a battery electrode plate according to an embodiment of the present disclosure.

### DETAILED DESCRIPTIONS OF THE EMBODIMENTS

The technical solutions in the embodiments of the present disclosure will be clearly and completely described below regarding the drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

An embodiment of the present disclosure provides a current collector, including a substrate and a conductive coating layer coated on the surface of the substrate, where the conductive coating layer comprises alternately arranged raised parts and recessed parts.

In some embodiments, the recessed structure of the conductive coating layer may be in various forms. for example, the conductive coating layer include raised stripes; or, the conductive coating layer does not include raised stripes, but is distributed with a plurality of grooves; or, the raised area and the recessed area are in a grid shape, and so on.

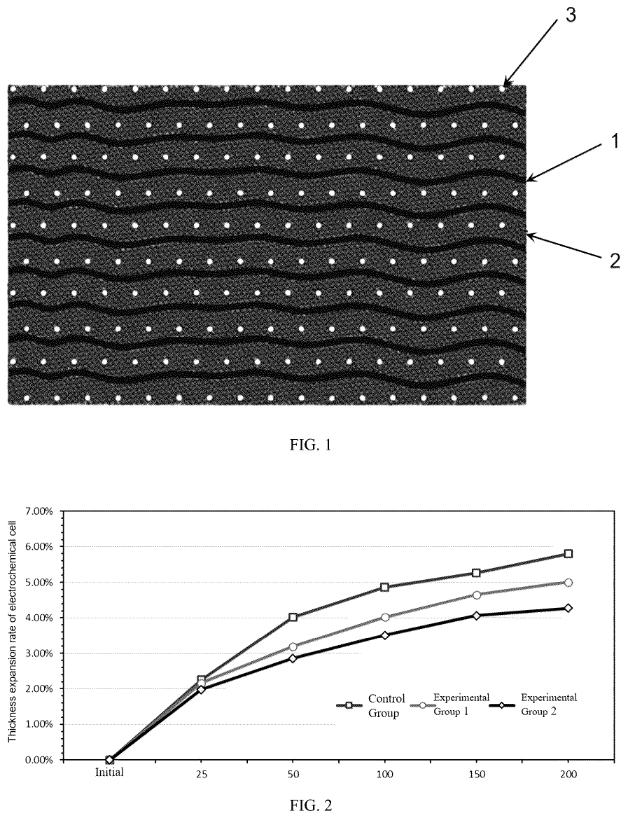

As shown in FIGS. 1-9, the embodiment of the present disclosure provides a current collector. A conductive coating layer 5 is positioned on the surface of a substrate 4. The conductive coating layer 5 has viscosity and roughness, which improves the smoothness of the surface of the substrate 4, improves the bonding strength between the active material and the substrate 4, and optimizes the surface performance of the current collector. Meanwhile, the conductive coating layer 5 includes a conductive filler having electrical conductivity, thereby improving the electrical conductivity of the battery. Moreover, in this embodiment, the conductive coating layer 5 is provided with a recessed structure, for example, the conductive coating layer 5 includes a plurality of raised stripes 1 that are convex and extend in a strip, and the raised stripes 1 are arranged at intervals along a first direction. The first direction may be the length direction of the substrate 4, or may be a width direction of the substrate 4, or may be an inclined direction intersecting the edge of the substrate. Of course, in a preferred embodiment, the first direction may be the length direction of the substrate 4; there is a recessed thin layer 2 between two adjacent raised stripes 1, that is, the coating layer at the raised stripes 1 is thick, and the coating layer in the area between two adjacent raised stripes 1 is thin, which is called the recessed thin layer 2 so that a plurality of recessed regions are formed on the conductive coating layer 5 to form a recessed structure.

It may be seen that the conductive coating layer 5 forms a three-dimensional undulating structure in the thickness direction, and the high areas and low areas are staggered. When the conductive coating layer 5 is coated with the active material, more active materials are filled in the recessed thin layer 2. The conductive coating layer 5 has a raised area and a recessed area, after the active material is coated, it is equivalent to having a flat area and a raised area, and the two materials are inserted into each other and compatible with infiltration.

In this way, on one hand, the component of the coated active material may be increased without increasing the thickness of the overall coating layer, and the energy density and electrical conductivity may be improved. In the second aspect, the plurality of recessed thin layers 2 are arranged in a distributed manner, so that the active material and the conductive coating layer 5 form an embedded insertion combined structure. In addition to the adhesive area of the cross-section layer, the circumferential side walls at the recessed thin layer 2 are the contact combined regions between the conductive coating layer 5 and the active material; and the active material can fully infiltrate the conductive coating layer 5, so that the bonding area and the compatibility degree between the active material and the conductive coating layer 5 may be effectively improved; the active material and the conductive coating layer 5 may be tightly combined, the bonding strength between the active material and the conductive coating layer 5 is significantly improved, the adhesiveness of the active material to the current collector is improved, the thickness expansion of the electrode plate and the battery cell is effectively inhibited, the recycling performance of the battery is improved, and the service life is prolonged. In a third aspect, the conductive coating layer 5 is usually formed by mixing a conductive filler and a binder, so that the viscosity of the conductive coating layer 5 is improved; in this embodiment, the bonding strength between the active material and the current collector is enhanced by optimizing the structure of the conductive coating layer 5, and the adhesion of the conductive coating layer 5 to the active material is improved relative to the aspect of the structure. Therefore, the excessive content of the binder in the conductive coating layer 5 may be avoided, even the content of the binder may be reduced; and the mass proportion of the conductive filler in the coating layer may be increased due to the reduction of the content of the binder, so that the energy density and the electrical conductivity of the battery may also be improved from the aspect.

By combining the effects of the above three aspects, the coating amount of the active material is increased, the proportion of the conductive filler in the conductive coating layer 5 is increased, and the conductive coating layer 5 is in fully contacted with and combined with the active material; the current collector provided by the embodiment not only improves the surface performance, but also improves the bonding power of the current collector and the active material, ensures that the active material is more firmly arranged on the surface of the current collector, and solves the problems in the prior art that the interface resistance between the active material and the current collector is largely due to insufficient bonding capability of the active material and the current collector, easy separation in the charging and discharging process. Moreover, the defects of poor electrical conductivity, easy damage to the conductive coating, and the like of the composite current collector containing the conductive coating layer 5 may be well overcame, a good conductive network between the current collector and the active material is effectively constructed, and the conductivity performance, the energy density, the rate performance and the cycling performance of the battery are improved.

Further, a plurality of blank areas 3 are distributed on the recessed thin layer 2, the blank area 3 refers to an area that is not coated with the conductive coating layer 5 material, and the cross-sectional area of the blank area 3 is small, as shown in FIG. 1, which is equivalent to that a plurality of blank points are distributed on the recessed thin layer 2. In this arrangement, the three-dimensional structure of the conductive coating layer 5 is further optimized, and in the thickness direction, the raised stripes 1, the recessed thin layer 2, and the blank areas 3 have different heights and are distributed in a staggered manner, which is equivalent to the conductive coating layer 5 being of a multi-layer stepped three-dimensional structure. When the active material is coated on the conductive coating layer 5, the blank areas 3 may accommodate more active materials, such areas are equivalent to the active material embedded into the conductive coating layer 5; in the areas of the recessed thin layer 2, the active material is in contact and merged with the conductive coating layer 5; and the areas at the raised stripes 1 is equivalent to the conductive coating layer 5 being embedded in the active material. Thus, the two material layers form a bonding structure that is inserted into each other and embedded into each other and are tightly connected, so that the bonding area is large, the active material may fully infiltrate the conductive coating layer 5 and is well and strongly combined with the conductive coating layer 5, and the adhesive power of the active material on the current collector is remarkably enhanced. Moreover, when the battery is used for a long time, the material layer is immersed in the electrolyte solution, the size of the material layer changes, and the thickness of the battery cell is expanded; because the conductive coating layer 5 provided by the present embodiment has a recessed area and is recessed layer by layer in a stepped manner, the active material and the conductive coating layer 5 are inserted, embedded, infiltrated and merged, and tightly combined and thoroughly merged; even if the battery is used for a long time, the bonding property of the active material and the current collector may be ensured, the active material may be prevented from falling off, the thickness expansion of the battery cell may be effectively inhibited, the safety problem caused by falling off is avoided, and the cycle service life of the battery is also prolonged.

It may be seen that, since the three-dimensional recessed structure of the conductive coating layer 5 is optimized, the connection adhesion structure of the conductive coating layer 5 and the active material is improved, the coating amount of the active material is increased, and the bonding area, the bonding degree of full infiltration, and the degree of connection tightness of the active material and the current collector are increased; and compared with the prior art, the bonding performance of the active material and the current collector is further improved, the lithium storage capacity of the active material in the battery is significantly improved, and the conductive stability, power, and durability are enhanced, thereby improving the performance of the battery, such as high rate, high energy density, long cycle life and the like.

In an embodiment, the distance between every two adjacent raised stripes 1 is equal. In an embodiment, the distance between every two adjacent raised stripes 1 is similar, for example, the distance between every two adjacent raised stripes 1 is not exactly the same, but is within the same numerical range, for example, 100 μm-200 μm. Alternatively, in an embodiment, the distance between every two adjacent raised stripes 1 changes regularly, for example, the distances may be gradually reduced or gradually increased along the width direction of substrate 1, or from the middle to the two ends.

In an embodiment, the blank area 3 is arranged in multiple-rows on the conductive coating layer 5, and a plurality of blank areas 3 are arranged in each row, as shown in FIG. 1. It may be seen that the row spacing of the blank areas 3 of every two adjacent rows is within the same numerical range, or each row spacing changes regularly.

In an embodiment, as shown in FIG. 1, the blank area 3 is uniformly distributed on the conductive coating layer 5, and further, the blank area 3 may be distributed in a display manner. If the distance between two adjacent raised stripes 1 is equal or in the same numerical range, the raised stripes 1, the recessed thin layer 2, and the blank areas 3 are regularly and uniformly arranged, so that the conductive coating layer 5 and the base material 4 have structural stability and consistency, the energy density and conductivity of all positions on the current collector are uniform and stable, and the stability and recycling performance of the battery is improved.

As shown in FIG. 1, in one embodiment, all the blank areas 3 on the conductive coating layer 5 are distributed in a matrix as a whole, and the blank areas 3 are arranged in a staggered manner between two adjacent rows or two adjacent columns This arrangement not only ensures the uniformity of the arrangement, but also has a staggered property, and the staggered arrangement of the blank areas 3 may further improve the bondability between the active material, and further optimize the battery performance

In an embodiment, the blank area is circular. Of course, in other embodiments, the blank area may be other shapes, such as a square or a rhombus, or a polygon. The diameter of the blank area may be 10 μm-50 μm, for example, 10 μm, 20 μm, 30 μm, 40 μm, 50 μm. Herein, the term “diameter” is not meant to define the blank area as circular. When the blank area has other shapes, its “diameter” is the diameter of a circle equal to the area of the blank area.

The recessed structure of the conductive coating layer 5 is formed by the raised stripes 1, the recessed thin layer 2, and the blank areas 3, which is convenient for the production and preparation of the conductive coating layer 5. For example, the conductive coating layer 5 is manufactured by intaglio printing: a trough is arranged on a brush roller, the trough is filled with a slurry, and the brush roller rolls on the surface of the substrate 4 to transfer the slurry from the trough to the surface of the substrate 4; and from the microscopic level, the moment when the slurry is transferred to the surface of substrate 4 is actually numerous droplets distributed in an array, and the droplets are merged to each other to form a coating layer. The area on the substrate 4 corresponding to the trough has a large number of liquid droplets, which are merged and gathered with each other. If the brush roller rotates at a high speed in the transverse direction, the liquid droplets distributed in the array are in the direction of high-speed rotation, that is, the liquid droplets have inertia force in the transverse direction; the transverse line area facing the center of each trough on the substrate 4, the front and back droplets are rapidly merged, and more slurry may also be gathered, thereby forming a raised stripe 1; and the remaining areas, the liquid droplets are gathered less to form a thin recessed coating layer. The area on the substrate 4 corresponding to the roller surface without or with less slurry will form a blank area 3 with very little slurry and incomplete fusion. the conductive coating layer 5 formed in this manner is shown in FIG. 1.

Of course, in another embodiment, after the slurry is uniformly coated on the substrate 4, a mold is used for pressing, so as to form the three-dimensional structure having the raised stripe 1, the recessed thin layer 2 and the blank area 3, as shown in FIG. 1. In two manners, the entire manufacturing process does not require a particularly complex composite process, which is easy for batch production, is convenient for preparation, and saves costs.

It should be noted that the structure of the conductive coating layer 5, as shown in FIG. 1, is shown under a microscope.

Specifically, the substrate 4 of the current collector may be made of a metal foil, such as a copper foil, an aluminum foil; or an alloy plated with a conductive material on the surface, for example, a stainless steel or an aluminum-cadmium alloy, plated with carbon, nickel, titanium, or silver on the surface is preferred; the hardness and wettability of the stainless steel or the aluminum-cadmium alloy meet the requirements, and the carbon, nickel, titanium or silver plating may have good conductivity. The substrate 4 may also be a polymeric membrane deposited with a conductive layer, and the polymeric membrane has better toughness; and the substrate 4 may also be formed by laminating and compounding a polymeric membrane and a metal foil.

In an embodiment, the surface roughness of the substrate 4 ranges from 0.2 μm to 3 μm, for example, 0.2 μm, 0.5μm, 0.8μm, 1 μm, 1.5 μm, 2 μm, 2.5 μm, 3 μm. The surface roughness of the substrate is tested by surface roughness profilometer waviness meter MARSURF M400 (Mahr, Germany) according to standard test method of GB3505-1983.

In an embodiment, the thickness of the substrate 4 ranges from 3 μm to 10 μm, for example, 3 μm, 4 μm, 5 μm, 6 μm, 7 μm, 8 μm, 9 μm, 10 μm.

In an embodiment, the volume resistance of the substrate ranges from 0.5 mΩto 10 mΩ, for example, 0.5 mΩ, 1 mΩ, 2 mΩ, 3 mΩ, 4 mΩ, 5 mΩ, 6 mΩ, 7 mΩ, 8 mΩ, 9 mΩ, 10 mΩ. The test method of volume resistance of the substrate includes: rolling the substrate, cutting it into a rectangular piece with approximately 5 cm×10 cm, placing the piece between two electrodes of a resistance meter (which were pressed by a upper and a lower cylindrical electrodes with a pressure of 0.4 MPa, and a cross-section diameter of the cylindrical electrodes is 12 mm), and testing the volume resistance after holding a test pressure for 3 seconds; the software of the resistance meter automatically reads the resistance data of the piece; and recorded volume resistance is calculated by averaging the data of 10 random positions of the piece.

Thus, the physical and chemical properties of the substrate 4 may be ensured by defining the thickness, surface roughness, and volume resistance of the substrate 4, thereby ensuring the performance of the substrate 4 and the battery prepared by the substrate 4.

A conductive coating 5 is disposed on the substrate 4, which may be formed by coating a slurry on the surface of the substrate 4. The slurry is formed by mixing a conductive filler, a dispersant, and a binder.

The conductive filler has conductivity and is one or more of carbon black, graphite, carbon nanotubes, graphene, metal nitride, metal carbide, metal boride, metal silicide, MAX phase ceramic (including Ti₃ SiC₂, Ti₂AlC, etc., is a novel processable ceramic material that attracts much attention), a complex of MAX phase ceramics and polyacetylene, polypyrrole, polythiophene, polyphenylene, polyphenylacetylene, or polyaniline. Alternatively, any of the above materials may be combined to form a high-density conductive filler. In an embodiment, the conductive filler may be carbon black.

The binder affects the bonding performance of the conductive coating layer 5 to the substrate 4 and the active material and may be one or more of polyamide, polyimide, polyethylene terephthalate, polybutylene terephthalate, polyphenylene ether, polyphenylene sulfide, polyethylene, polyvinyl fluoride, maleic anhydride grafted polyethylene, polypropylene, polyvinylidene fluoride, epoxy resin, ethylene-vinyl acetate copolymer, butadiene-acrylonitrile copolymer, acrylonitrile-butadiene-styrene copolymer, polystyrene, polyformaldehyde, styrene-butadiene rubber, phenolic resin, polytetrafluoroethylene, tetrafluoroethylene-hexafluoropropylene copolymer, tetrafluoroethylene-hexafluoropropylene-vinylidene fluoride copolymer, or ethylene-acrylic acid copolymer. The binder may also be any combination of several of them to form a viscous binder. In one embodiment, the binder is a polyacrylic acid aqueous binder, which has good bonding property and good fusion properties, may reduce the content of the binder as much as possible based on ensuring that the density of each part of the coating layer is basically consistent, thereby improving the content of the conductive filler and improving the conductive performance

The dispersant determines the dispersion and uniform distribution of the conductive filler in the coating layer and may be one or more of polyvinylpyrrolidone, sodium carboxymethyl cellulose, polysorbate-80, lithium carboxymethyl cellulose, hydroxyethyl cellulose, sodium lignin sulfonate, sodium deoxycholate, sodium dodecyl benzene sulfonate, polyethylene glycol, sodium dodecyl sulfate, or cetyl-trimethyl ammonium bromide. The dispersant may also be any combination of several of them to form a powerful dispersant. In an embodiment, the dispersant is a carboxymethyl cellulose material, such as sodium carboxymethyl cellulose or lithium carboxymethyl cellulose, so that the conductive filler may be mixed more uniformly in the slurry, thereby ensuring the density consistency of the conductive coating layer 5, ensuring the conductive performance, the performance of cyclic charging and discharging, and the service life. For example, the selected carboxymethyl cellulose material has a molecular weight of 100,000 Da-200,000 Da (for example, 100,000 Da, 120,000 Da, 140,000 Da, 160,000 Da, 180,000 Da, 200,000 Da), and a degree of substitution is 0.7-0.9. In another embodiment, the dispersant is a mixture of a polyvinylpyrrolidone and the methyl cellulose material, and the selected polyvinylpyrrolidone has a molecular weight of 5,000 Da-1,300,000 Da (for example, 5,000 Da, 10,000 Da, 100,000 Da, 500,000 Da, 1,000,000 Da, 1,300,000 Da). In an embodiment, based on the total weight of the conductive coating layer, the content of the polyvinylpyrrolidone is 3.5%-12.5% (for example, 4%, 5%, 6%, 7%, 8%, 9%, 10%, 11%, 12%), and the content of the methyl cellulose material is 1.8%-11.8% (for example, 2%, 3%, 4%, 5%, 6%, 7%, 8%, 9%, 10%, 11%).

In an embodiment, based on the total weight of the conductive coating layer, the content of the conductive filler is 43.1%-71% (for example, 45%, 50%, 55%, 60%, 65%, 70%), the content of the dispersant is 5.3%-1% (f (for example, 45%, 50%, 55%, 60%, 65%, 70%), and the content of the binder is 6.5%-32.6% (for example, 8%, 10%, 15%, 20%, 25%, 30%).

The conductive filler and the dispersant are mixed and stirred in a certain ratio, and then mixed and stirred with the binder in a certain ratio to prepare a slurry; and the mass ratio of the conductive filler, the dispersant, and the binder in the slurry meet the requirements. The slurry is coated on the substrate 4 to form the conductive coating layer 5 through the preparing method in the above embodiment.

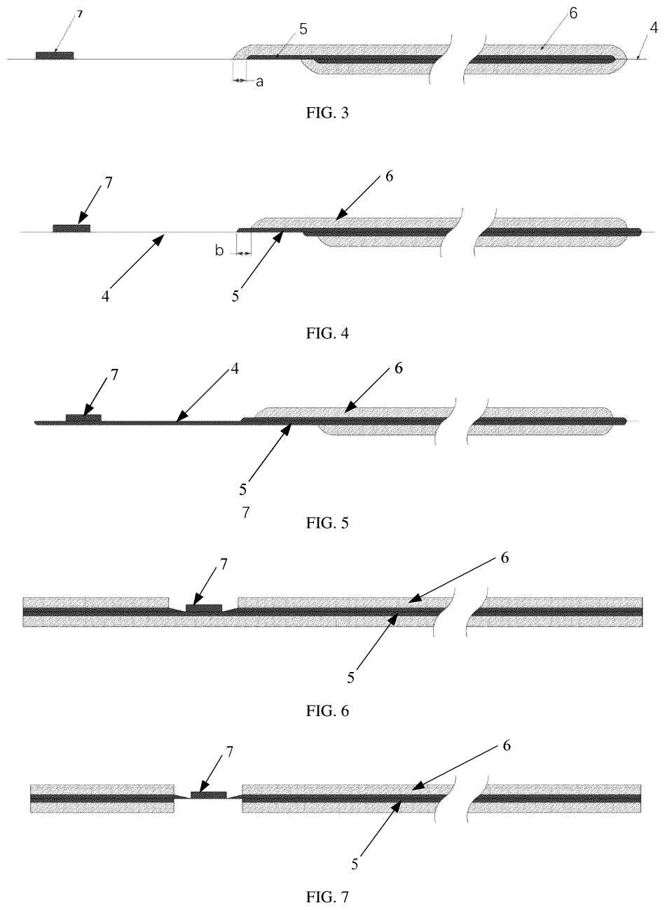

The conductive coating layer 5 may completely or partially cover the material surface of the substrate 4. A tab 7 is positioned on the surface of the battery electrode plate, and the tab 7 is located on one side of the substrate. In one embodiment, a tab connection area is positioned on the side of the material surface, and the area is not coated with the conductive coating layer 5, as shown in FIG. 3 and FIG. 4, that is, the tab 7 is directly located on the surface of the substrate 4. In an embodiment, the area is coated with the conductive coating layer 5, and the tab 7 is located on the surface of the conductive coating layer 5 away from the substrate 4, so that the connection strength between the tab and the current collector may be enhanced.

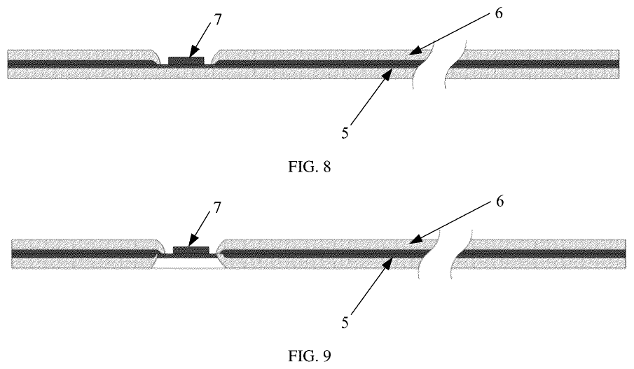

When the tab connection area is not coated with the conductive coating layer 5, the edge of the conductive coating layer 5 may have a distance from the area as shown in FIG. 3, FIG. 4, FIG. 5, FIG. 8, and FIG. 9, or may extend to an edge of the tab 7 connection area as shown in FIG. 6 and FIG. 7. On the other side of the substrate 4, the area opposite to the tab 7 may be coated with the conductive coating layer 5, or may be a blank foil area without the conductive coating layer 5. When the area opposite the tab 7 is coated with the conductive coating layer 5, the conductive coating layer 5 may also cover the entire surface of the substrate 4 on that side.

In an embodiment, the pore size of the conductive coating layer ranges from 50 nm to 2000 nm, for example, 50 nm, 100 nm, 200 nm, 500 nm, 800 nm, 1000 nm, 1500 nm, 2000 nm. In the present disclosure, the pore of the conductive coating layer refers to the voids formed by the pile of the conductive filler particles. And the pore size is tested according to standard test method of ISO 15901-1-2016.

In an embodiment, the thickness of the conductive coating layer 5 is 0.4 μm-0.8 μm (for example, 0.4 μm, 0.5 μm, 0.6 μm, 0.7 μm, 0.8 μm), which refers to the thickness of the raised parts, i.e., the vertical distance between the highest point of the raised parts and the surface of the substrate. In an embodiment, the thickness of the recessed parts is 0.1 μm-0.6 μm, i.e., the vertical distance between the highest point of the recessed parts and the surface of the substrate.

In an embodiment, the overall thickness of the current collector is 2 μm-20 μm, for example, 2 μm, 3 μm, 4 μm, 5 μm, 8 μm, 10 μm, 12 μm, 15 μm, 20 μm; and the thickness of the current collector and the density performance in the unit is ensured.

In an embodiment, the distance between two adjacent raised stripes is 60 μm-250 μm, for example, 60 μm, 70 μm, 80 μm, 90 μm, 100 μm, 120 μm, 140 μm, 150 μm, 160 μm, 180 μm, 200 μm, 210 μm, 220 μm, 230 μm, 240 μm, 250 μm. In an embodiment, the distance between two adjacent raised stripes is 100 μm-200 μm. In the present disclosure, the distance between two adjacent raised stripes refers to the distance between the adjacent edges of the two raised stripes.

In an embodiment, the width of the raised stripe is 30 μm-150 μm, for example, 30 μm, 40 μm, 50 μm, 60 μm, 70 μm, 80 μm, 90 μm, 100 μm, 110 μm, 120 μm, 130 μm, 140 μm, 150 μm. In an embodiment, the width of the raised stripe is 50 μm-100 μm.

In an embodiment, the distance between two adjacent blank areas 3 in the same row is 80 μm-120 μm (for example, 80 μm, 90 μm, 100 μm, 110 μm, 120 μm); and/or the distance between two adjacent blank areas 3 in the same column is 80 μm-120 μm (for example, 80 μm, 90 μm, 100 μm, 110 μm, 120 μm). In the present disclosure, the distance between two adjacent blank areas refers to the distance between the two closest points of the two adjacent blank spaces.

In an embodiment, the volume resistance of the whole current collector is 1 mΩ-5 mΩ(for example, 1 mΩ, 2 mΩ, 3 mΩ, 4 mΩ, 5 mΩ); and the good conductivity of the current collector is ensured by limiting the structural parameters of the conductive coating layer 5.

In the embodiments of the present disclosure, further provided is a battery electrode plate, including the current collector as described in any one of the above embodiments and an active material layer 6 coated on the surface of the current collector. In this embodiment, the bonding performance between the battery electrode plate, the current collector, and the active material is good, which enhances the conductivity stability, power performance, and durability of the battery electrode plate, and improves the performance of the battery, such as high rate, high energy density, and long cycle life. The derivation process of the beneficial effect is basically the same as that of the beneficial effects of the current collector in the above embodiment, and details are not described herein again.

The active material layer 6 may completely cover the conductive coating layer 5, or may partially cover the conductive coating layer 5. A tab 7 is positioned on one side of the substrate 4; on the other side of the substrate 4, an area, opposite to the tab 7, may be a blank foil area, that is, not coated with an active material, as shown in FIG. 3, FIG. 4 and FIG. 7, or may be coated with a conductive coating 5, as shown in FIG. 5, FIG. 6, FIG. 8, and FIG. 9. When the area opposite to the tab 7 is coated with the conductive coating layer 5, the active material layer 6 may be coated on the area, as shown in FIG. 6 and FIG. 8, or the conductive coating layer 5 may be coated without the active material layer 6, as shown in FIG. 5, FIG. 7, and FIG. 9.

Meanwhile, the edge of the conductive coating layer 5 and the edge of the corresponding active material layer 6 may be in an aligned state, as shown in the lower side surface of FIG. 7, or may have a distance. The distance between the two edges may be controlled within 0-5 mm. As shown in FIG. 3, the active material layer 6 may cover the conductive coating layer 5, and the edge thereof exceeds the corresponding edge of the conductive coating layer 5; the size of the exceeding part is a, and the value of the a is 0-5 mm (for example, 0 mm (i.e., in an aligned state), 1 mm, 2 mm, 3 mm, 4 mm, 5 mm). As shown in FIG. 4, it may also be that the edge of the conductive coating layer 5 exceeds the edge of the corresponding active material layer 6; the size of the exceeding part is b, and the value range of b is 0-5 mm (for example, 0 mm (i.e., in an aligned state), 1 mm, 2 mm, 3 mm, 4 mm, 5 mm).

As shown in FIGS. 3 to 9, the edges of the conductive coating layer 5 and the active material layer 6 may be right-angled edges, rounded arc edges, or beveled edges in some cases, all of which are embodiments in the present disclosure.

In the embodiments of the present disclosure, further provided is a battery, including the current collector as described in any one of the above embodiments and the active material layer 6 coated on the surface of the current collector. In this embodiment, the bonding performance between the battery, the current collector, and the active material is good, which enhances the conductivity stability, power performance, and durability of the battery, and improves the performance of the battery, such as high rate, high energy density, and long cycle life. The derivation process of the beneficial effect is basically the same as that of the beneficial effects of the current collector in the above embodiment, and details are not described herein again.

In the present disclosure, parameters defined by numerical ranges refer to average parameters, such as “diameter” refers to “average diameter”, “pore size” refers to “average pore size”, and so on.

The technical solutions of the present disclosure will be clearly and completely described below with reference to the examples and the drawings. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

The experimental methods used in the following examples are conventional unless otherwise specified. Reagents, materials, and the like used in the examples described below are commercially available without special description.

### EXAMPLE 1

(1) A conductive slurry was obtained by mixing 60 parts by weight of carbon black, 27 parts by weight of styrene-butadiene rubber (SBR) adhesive, 3 parts by weight of polyvinylpyrrolidone (whose molecular weight is 40,000) and 10 parts by weight of carboxymethyl cellulose (whose molecular weight is 150,000 Da, degree of substitution is 0.8).
(2) Coated the conductive slurry onto the substrate (which is copper foil with surface roughness of 1.3, thickness of 5 μm and volume resistance of 1.6 mΩ), pressed and molded it with a mold, and dried, so that a conductive coating layer was formed that raised stripes 1 arranged at intervals as shown in FIG. 1, and a recessed thin layer 2 positioned between adjacent raised stripes 2, and a plurality of blank areas 3 which were not coated with conductive slurry were distributed on the recessed thin layer 2.

The width of the raised stripes was about 60 μm, the distance between every two adjacent raised stripes was about 145 μm, the diameter of the blank area was about 25 μm, and the distance between two adjacent blank areas was about 90 μm. The pore size of the conductive coating was 300 nm and the thickness was 0.6 μm.

The conductive coating layer partially covered the surface of the substrate, as shown in FIG. 3, and the tab connection area was not coated with the conductive coating.
(3) Prepared an negative active material slurry consisting of graphite, CMC and SBR at a mass ratio of 96.5:2:1.5, coated it on the surface of the conductive coating layer obtained in step (2) and dried it, with a coating surface density of 7.7 mg/cm². After drying, rolled it at a compaction density of 1.7 G/cm³ to form a electrode plate structure as shown in FIG. 3, where the edge of the active material layer extended beyond the edge of the conductive coating by 1.5 mm to obtain a negative electrode plate.

Prepared an positive active material slurry consisting of LiCoO₂, PVDF and conductive carbon Super-P at a mass ratio of 95:2:3, and N-methylpyrrolidone (NMP) was used as solvent, coated it on the surface of a aluminum foil with a thickness of 10 μm and dried it, with a coating surface density of 14.5 mg/cm². After drying, rolled it at a compaction density of 4.0 G/cm³ to form a positive electrode plate.

### Assemble a Battery

A polyethylene (PE) porous polymer film was used as an isolating film. A positive electrode plate, a isolating film and a negative electrode plate were sequentially stacked, so that the isolating film was positioned between the positive electrode plate and the negative electrode plate to play a role of isolation, and the cell was obtained by winding. A solvent solution was prepared by mixing propylene carbonate (PC), ethylene carbonate (EC) and diethyl carbonate (DEC) with a weight ratio of 1:1:1; Lithium Hexafluorophosphate (LiPF6) was added at a concentration of about 1.12 mol/L; then fluoroethylene carbonate (FEC) was added at a concentration of 10 wt %; and after uniformly mixed, a electrolyte was obtained. The battery cell was packaged into a packaging film 2 (a aluminum-plastic film containing a outer nylon layer, a middle Al layer and a inner PP layer). After the battery cell was dried, the electrolyte was injected and packaged. After formation, degassing and edge cutting, the full battery was obtained. The electrical performance of the obtained full battery was tested.

### Example Group 2

This set of examples is intended to illustrate the effect of the structure of the conductive coating.

This set of Examples was carried out with reference to Example 1, except that the dimensions of the mold used in Step (2) were changed so that the resulting conductive coatings had the following sizes (dimensions not listed were the same as Example 1):

Example 2a, the width of the raised stripes was about 50 μm, and the distance between every two adjacent raised stripes was about 100 μm;

Example 2b, the width of the raised stripes was about 100 μm, and the distance between every two adjacent raised stripes was about 200 μm;

Example 2c, the diameter of the blank area was about 15 μm, and the distance between adjacent two blank areas was about 80 μm;

Example 2d, the diameter of the blank area was about 50 μm, and the distance between adjacent two blank areas was about 120 μm;

Example 2e, the pore size of the conductive coating was 200 nm;

Example 2f, The pore size of the conductive coating was 500 nm.

### Comparative Example 1

This was done with reference to Example 1, except that the conductive slurry was coated directly onto the substrate in Step (2) without pressed or molded with a mold.

### Test Cases

Charged the cell to full power, measured the thickness of cell plane with plate thickness measuring instrument, record as T0; then cycled the cell for 50, 100, and 200 times respectively, recorded as Ti (i=1, 2, 3, 4) at each node, calculated cell thickness expansion rate under different cycle times based on Expansion Rate %=(Tᵢ−T₀)/T₀*100%. The results are noted in Table 1.

In addition, the results of Example 1 (labeled as “Experimental Group 2” in the figure) and Example 2b (labeled as “Experimental Group 1” in the figure) and Comparative Example 1 (labeled as “Control Group” in the figure) were plotted as shown in FIG. 2.

TABLE 1

| | cell thickness expansion rate | | |
|---|---|---|---|
| | (%) under different cycle times | | |
| | 50 times | 100 times | 200 times |
| Example 1 | 2.83 | 3.51 | 4.35 |
| Example 2a | 3.21 | 4.16 | 4.96 |
| Example 2b | 3.24 | 4.05 | 4.98. |
| Example 2c | 3.19 | 4.23 | 4.90 |
| Example 2d | 3.20 | 4.15 | 4.85 |
| Example 2e | 3.05 | 3.97 | 4.59 |
| Example2f | 3.11 | 4.02 | 4.64 |
| Comparative Example 1 | 4.01 | 4.83 | 5.79 |

As can be seen from Table 1 and FIG. 2, the batteries of the present disclosure have good charge/discharge cycle performance and long cycle life.

The basic principles of the present disclosure have been described above regarding specific embodiments, however, it should be noted that the advantages, benefits, effects, and the like mentioned in this disclosure are merely examples and are not limited, and these advantages, benefits, effects and the like may not be considered to be necessary for each embodiment of the present disclosure. In addition, the specific details disclosed above are merely for the purpose of example and facilitating understanding, and are not limited, and the above details are not intended to limit the present disclosure to be implemented by using the specific details described above.

The above description of the disclosed aspects is provided to enable any person skilled in the art to make or use the present disclosure. Various modifications to these aspects may be readily apparent to those skilled in the art, and the generic principles defined herein may be applied to other aspects without departing from the scope of this disclosure. Therefore, the present disclosure is not intended to be limited to the aspects illustrated herein, but rather to the widest scope consistent with the principles and novel features disclosed herein.

The foregoing description has been presented for purposes of illustration and description. Moreover, this description is not intended to limit the embodiments of the present disclosure to the forms disclosed herein. Although multiple example aspects and embodiments have been discussed above, those skilled in the art may recognize certain variations, modifications, changes, additions, and sub-combinations thereof.

The foregoing is merely a preferred embodiment of the present disclosure and is not intended to limit the present disclosure. Any modification, equivalent replacement, etc. made within the spirit and principle of the present disclosure should be included within the protection scope of the present disclosure.

What is claimed is:

1. A current collector, comprising a substrate and a conductive coating layer coated on a surface of the substrate, wherein the conductive coating layer comprises alternately arranged raised parts and recessed parts.

2. The current collector according to claim 1, wherein the raised parts comprises raised stripes, which are convex and arranged at intervals along a first direction; and
the recessed parts comprises a recessed thin layer, located between two adjacent raised stripes, and forming a recessed structure on the conductive coating layer.

3. The current collector according to claim 2, wherein a plurality of blank areas, not coated with the conductive coating layer, are distributed on the recessed thin layer.

4. The current collector according to claim 3, wherein the blank areas are distributed in a matrix; and/or the blank areas are arranged in multiple-rows, and the blank areas of two adjacent rows are arranged in a staggered manner.

5. The current collector according to claim 3, wherein a diameter of the blank area is 10 μm-50 μm; and/or a distance between two adjacent blank areas is 80 μm-120 μm.

6. The current collector according to claim 2, wherein a distance between two adjacent raised stripes is 60 μm-250 μm; and/or a width of the raised stripe is 30 μm-150 μm.

7. The current collector according to claim 1, wherein a pore size of the conductive coating layer ranges from 50 nm to 2000 nm.

8. The current collector according to claim 1, wherein a thickness of the conductive coating layer is 0.4 μm-0.8 μm; and/or a thickness of the current collector is 2 μm-20 μm.

9. The current collector according to claim 1, wherein a volume resistance of the current collector is 1 mΩ-5 mΩ.

10. The current collector according to claim 1, wherein a surface roughness of the substrate ranges from 0.2 μm to 3 μm.

11. The current collector according to claim 1, wherein a thickness of the substrate ranges from 3 μm to 10 μm.

12. The current collector according to claim 1, wherein a volume resistance of the substrate ranges from 0.5 mΩto 10 mΩ.

13. The current collector according to claim 1, wherein a dispersing agent for preparing the conductive coating layer is polyvinyl pyrrolidone and/or a carboxymethyl cellulose material.

14. The current collector according to claim 1, wherein a binder of the conductive coating layer is a polyacrylic acid aqueous binder.

15. The current collector according to claim 1, wherein the substrate is configured to be any one of the following materials:
a metal foil;
a stainless steel or an aluminum-cadmium alloy, plated with carbon, nickel, titanium, or silver on the surface;
a polymeric membrane deposited with a conductive layer; or
a substrate formed by laminating and compounding a polymeric membrane and a metal foil.

16. A battery electrode plate, comprising the current collector according to claim 1 and an active material layer coated on the surface of the current collector.

17. The battery electrode plate according to claim 16, wherein a tab is positioned on the surface of the battery electrode plate and located on the surface of the substrate; or the tab is located on the surface of the conductive coating layer away from the substrate.

18. The battery electrode plate according to claim 16, wherein a tab is positioned on one side of the substrate; and on the other side of the substrate, an area, opposite to the tab, is a blank foil area, or coated with a conductive coating, with or without being coated by an active material layer.

19. The battery electrode plate according to claim 18, wherein the conductive coating is coated by an active material layer completely or partially; and,
the active material layer covers the conductive coating layer, and the edge of the active material layer exceeds the corresponding edge of the conductive coating layer; the size of the exceeding part is a, and a value of a is 0-5 mm; or
the edge of the conductive coating layer exceeds the edge of the corresponding active material layer; the size of the exceeding part is b, and a value range of b is 0-5 mm.

20. A battery, comprising the current collector according to claim 1.
